(19) United States
(12) Patent Application Publication
(10) Pub. No.: US 2021/0247419 A1
(43) Pub. Date: Aug. 12, 2021

(54) Ship Real Wind Measuring Device Calibration Method

(71) Applicant: DALIAN UNIVERSITY OF TECHNOLOGY, Dalian, Liaoning (CN)

(72) Inventors: Dazhi WANG, Dalian, Liaoning (CN); Xiaoyan GUO, Dalian, Liaoning (CN); Yuanda CI, Dalian, Liaoning (CN); Feng CAI, Dalian, Liaoning (CN); Xiao WANG, Dalian, Liaoning (CN); Shaoyan ZUO, Dalian, Liaoning (CN)

(21) Appl. No.: 17/057,019

(22) PCT Filed: May 28, 2020
(86) PCT No.: PCT/CN2020/092928

§ 371 Date: Nov. 19, 2020

(30) Foreign Application Priority Data
Aug. 24, 2019 (CN) 201910786239.9

(51) Int. Cl. G01P 21/00; B63B 79/30; B63B 79/15; G01P 13/04; G01M 9/02; G06N 3/02

(52) U.S. Cl. CPC G01P 21/00; B63B 79/30; B63B 79/15; B63B 79/40; G01M 9/02; G06N 3/02; G01P 13/045

(57) ABSTRACT

The present invention belongs to the field of ship engineering, and provides a ship real wind measuring device calibration method. In this method a ship sway simulator is build using a 2-axis ganged platform, natural wind is simulating generated using a wind tunnel flow field. Then the ship sway simulator is controlled to simulate the ship spatial motion under the disturbance of stormy waves. Furthermore, the data of the wind speed and direction is obtained under different sway angles and speeds. So that the database of wind direction and speed measurement, attitude measurement, actual wind direction and speed measurement is formed. Subsequently, a calibration model based on BP neural network is constructed using this database, a ship real wind direction and speed calibration algorithm is formed, which can calibrate a ship real wind measuring device.

### TECHNICAL FIELD

The present invention belongs to the field of ship engineering, and particularly relates to a ship real wind measuring device calibration method.

### BACKGROUND

Wind speed and direction are important parameters for ship maneuvering control, and the improvement of the measurement accuracy of ship wind speed and direction is of great significance for safe landing of shipboard aircraft, rescue and relief work, ship berthing and departing. At present, shipborne wind measuring sensors generally measure relative wind, and calculate real wind with the information of ship heading and speed. However, the real wind of a ship is not only related to ship heading and speed, but also affected by ship spatial motion such as roll and pitch, especially that ship sway in the heavy weather will cause a large change in the ship spatial position, leading to a large error in real wind measurement. The real wind measuring device is formed by combining a ship attitude sensor and a wind speed and direction measuring sensor, which can eliminate the error of ship spatial motion. However, for the high-precision real ship measurement of the real wind measuring device, it is also required to establish a data base value for ship swag to correct the real wind measurement data. The high-precision measurement of ship real wind cannot be achieved by simply improving the precision of the sensor.

### SUMMARY

The technical problem to be solved in the present invention is to overcome the above technical defects and provide a ship real wind measuring device calibration method. In this method a ship sway simulator is building using 2-axis ganged platform, a real wind measuring device composed of a wind direction and speed measurement module and a ship attitude measurement module is fixed on the ship sway simulation platform. A wind tunnel is used to simulate natural wind, the ship sway simulator is controlled to simulate the spatial motion under the disturbance of stormy waves. Then the data of wind direction and speed is obtained under different sway angles and speeds. And the database of wind direction and speed measurement, attitude measurement, actual wind direction and speed is analyzed. Subsequently, a calibration model based on BP neural network of optimized genetic algorithm is constructing using this database, a real wind direction and speed calibration algorithm is formed, which can calibrate a ship real wind measuring device. Finally, this method reduces the dynamic measurement error of the wind direction and speed in the ship space motion state and realizes the accurate measurement of the real wind in the ship motion state.

The present invention adopts the following technical solution:

A ship real wind measuring device calibration method, comprises the following specific steps:

1) Establishing a Ship Sway Simulator

The ship sway simulator comprises a lateral sway calibration module 14, a vertical sway calibration module 13, a sway control module 15, a real wind measuring device fixed module 12 and a host computer 16;

The lateral sway calibration module 14 and the vertical sway calibration module 13 have the same structure, and both comprise a sway calibration floor guideway 3, a sway calibration platform guideway 5, a sway calibration slipway 8, a sway fixed base 4, a driving motor 7, a rack 9 and a screw 6; the upper surface of the sway fixed base 4 is a concave arc surface, two sway calibration floor guideways 3 and two sway calibration platform guideways 5 are symmetrically fixed on the concave arc surfaces of the sway fixed bases 4, and the two sway calibration platform guideways 5 are respectively located on the outer sides of the two sway calibration floor guideways 3 to form arc guide rail components; the lower surface of the sway calibration slipway 8 is a convex arc surface, two arc grooves are formed symmetrically in both ends of the lower surface and matched with the arc guide rail component of the sway fixed base 4 so that the sway calibration slipway 8 sways on the sway fixed base 4; the rack 9 is arranged in the middle of the lower surface of the sway calibration slipway 8, and a plurality of mounting holes are formed in the upper surface of the sway calibration slipway 8; the driving motor 7 is installed on the outer side of the sway fixed base 4; one end of the screw 6 is connected with the driving motor 7 through a coupling, and the other end is engaged with the rack 9; and the sway calibration slipway 8 is driven by the driving motor 7 to move along the arc guide rail component on the sway fixed base 4 to realize the simulation of the ship sway attitude;

The lateral sway calibration module 14 and the vertical sway calibration module 13 are arranged at an included angle of 90° from top to bottom, and fixedly connected through the lower surface of the sway fixed base 4 located above and the upper surface of the sway calibration slipway 8 located below;

The real wind measuring device fixed module 12 comprises a supporting platform 1 and studs 2; a plurality of studs 2 are provided, the top ends thereof are symmetrically installed on the bottom of the supporting platform 1, and the bottom ends thereof are installed in the mounting holes in the upper surface of the sway calibration slipway 8 located above; and a plurality of mounting holes are processed in the upper surface of the supporting platform 1 for installation of the real wind measuring device and adjustment of the installation direction according to experimental requirements;

The sway control module 15 is connected with the two driving motors 7 and the host computer 16, and the real wind measuring device is fixed on the supporting platform 1 through the mounting holes in the supporting platform 1 and connected with the host computer 16.

2) Acquiring Wind Direction and Speed Data

First, placing the ship sway simulation platform vertically and statically, adopting the wind tunnel to simulate natural wind, installing the real wind measuring device on the ship sway simulation platform to measure the wind direction and speed, and transmitting the collected data to the host computer 16 as the real wind calibration reference values; then, sending instructions through the host computer 16 to the sway control module 15 which controls the swag angles and speeds of the lateral sway calibration module 14 and the vertical sway calibration module 13 to respectively simulate the roll and pitch motion of the ship at different sway speeds and angles; and finally, sorting out the data of the wind direction and speed collected by the real wind measuring device and the attitude of the ship sway simulation platform by the host computer 16 to form a wind direction and speed database with the sway angle and speed as variables.

3) Calibrating Real Wind

First, normalizing the data of wind direction and speed and ship attitude collected by the host computer 16 in step 2); then, constructing a BP neural network calibration model through the normalized data as follows: using the data of attitude and wind direction and speed as input parameters of the model, using the real wind calibration reference values as output parameters of the model, and adopting the genetic algorithm to obtain optimal individuals to assign initial weight values and thresholds to the neural network, wherein the input parameters include roll angle, roll angular velocity, pitch angle, pitch angular velocity, measured wind direction and measured wind speed, and the output parameters include real wind direction and real wind speed of the wind tunnel measured by the ship real wind measuring device when the ship sway simulation platform is placed vertically and statically; obtaining the BP neural network calibration model that best maps the relationship between the ship spatial motion and the real wind measurement by training to form a ship real wind direction and speed calibration algorithm so as to realize the calibration of the ship real wind measuring device; and finally, inputting the data of wind direction and speed and ship attitude measured in the actual ship environment into the BP neural network calibration model to calculate the real-time real wind direction and real wind speed so as to make a real-time correction to the data of wind direction and speed measured in the actual ship.

The present invention has the following beneficial effects: the ship real wind measuring device calibration method effectively simulates the lateral and vertical sway motion of a ship to form a real wind direction and speed calibration algorithm, which calibrates the ship real wind measuring device, corrects the measured data of wind direction and speed, reduces the dynamic measurement error of the wind direction and speed in the ship spatial motion state and enhances the accuracy and reliability of the ship real wind data.

### DESCRIPTION OF DRAWINGS

FIG. 1 is a three-dimensional assembly diagram of a ship sway simulation stand of the present invention.

FIG. 2 is a schematic diagram of a ship real wind measuring device calibration method of the present invention.

In the figures: 1 supporting platform; 2 stud; 3 sway calibration floor guideway; 4 sway fixed base; 5 sway calibration platform guideway; 6 screw; 7 driving motor; 8 sway calibration slipway; 9 rack; 10 ultrasonic wind direction and speed measurement module; 11 ship attitude measurement module; 12 real wind measuring device fixed module; 13 vertical sway calibration module; 14 lateral sway calibration module; 15 sway control module; and 16 host computer.

### DETAILED DESCRIPTION

Specific embodiments of the present invention are described below in detail in combination with the technical solution and accompanying drawings.

First, the real wind measuring device composed of the ultrasonic wind direction and speed measurement module 10 and the ship attitude measurement module 11 is fastened on the real wind measuring device fixed module 12 of the ship sway simulation platform; then, the wind tunnel is set to a constant value, the vertical static wind direction and speed of the ship sway simulation platform are measured as the reference values for real wind calibration, and the rotation distance and speed parameters of the ship sway simulation platform are changed through the host computer 16 to respectively simulate the roll and pitch motion of the ship at different sway speeds and angles; the data of the wind direction and speed collected by the ship real wind measuring device is sorted out to form a wind direction and speed database with the sway angle and speed as variables; and finally, the database of the wind direction and speed data, attitude data and actual wind direction and speed is analyzed and processed to construct a BP neural network calibration model which is optimized with the genetic algorithm to form a real wind direction and speed calibration algorithm so as to calibrate the ship real wind measuring device.

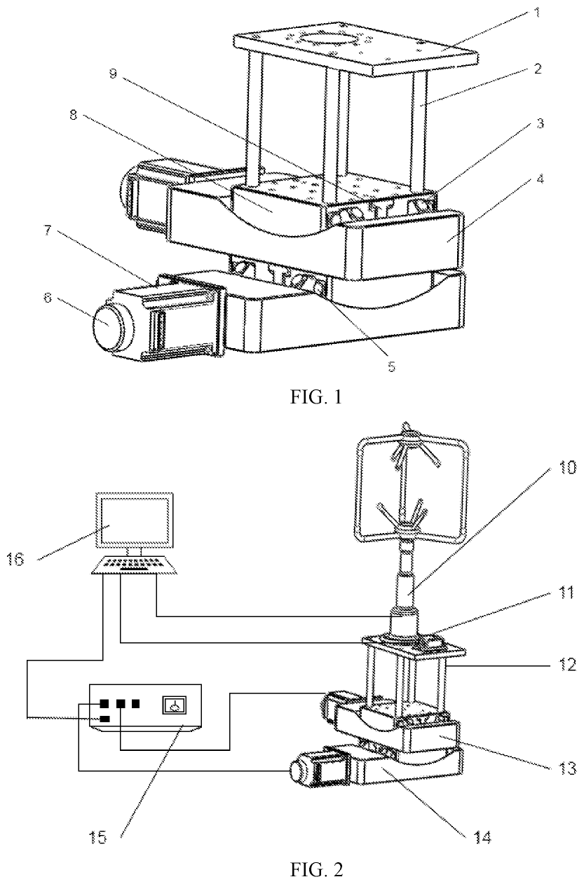

The specific implementation steps of the embodiment are as follows (as shown in FIG. 1 and FIG. 2):

1) Establishing a Ship Sway Simulator

FIG. 1 is a three-dimensional assembly diagram of a ship sway simulation platform, wherein the lateral sway calibration module 14 and the vertical sway calibration module 13 have the same internal structure, comprising a sway fixed base 4, a driving motor 7, a screw 6, a rack 9, a sway calibration floor guideway 3, a sway calibration platform guideway 5 and a sway calibration slipway 8; and the real wind measuring device fixed module 12 comprises a rectangular supporting platform 1, hexagon studs 2 and hexagon bolts. In the real wind measuring device fixed module 12, the supporting platform 1 is fastened to the upper surface of the sway calibration slipway 8 of the vertical sway calibration module 13 through the studs 2, a through hole with the diameter of 80 mm is processed in the middle position of the front end of the supporting platform 1, three M3 threaded holes are processed in the tail end, and the real wind measuring device composed of the ultrasonic wind direction and speed measurement module 10 and the ship attitude measurement module 11 is fastened on the supporting platform 1 through the bolts; and meanwhile, 12 threaded holes with the diameter of 7 mm are uniformly distributed around the through hole to ensure that the N direction (wind direction 0°) of the real wind measuring device can be adjusted by 360° according to the test requirements.

The lateral sway calibration module 14 and the vertical sway calibration module 13 have the same structure. The vertical sway calibration module 13 is taken as an example to illustrate that: the upper surface of the middle part of the sway fixed base 4 is a concave arc surface, and the sway calibration floor guideway 3 and the sway calibration platform guideway 5 installed on the concave arc surface are the arc guide rails corresponding to the concave arc surface; the lower surface of the sway calibration slipway 8 is a convex arc surface, two arc grooves are formed symmetrically in both ends of the lower surface and matched with the arc guide rail of the sway fixed base so that the sway calibration slipway 8 sways on the sway fixed base 4; a plurality of threaded mounting holes uniformly distributed are processed in the upper surface of the sway calibration slipway 8; the driving motor 7 drives the screw 6 in the sway fixed base 4 through a coupling to rotate, and the engaged transmission of the racks 9 in the middle of the two sway calibration floor guideways 3 and the screws 6 realizes the vertical motion of the sway calibration slipway 8 along the guide rail surface; and the lateral sway calibration module 14 and the vertical sway calibration module 13 are arranged at an included angle of 90°, the vertical sway calibration module 13 is arranged above, the sway fixed base 4 thereof is fastened on the upper surface of the sway calibration slipway 8 of the lateral sway calibration module 14 through threads, the sway control module 15 drives the sway calibration slipway 8 to sway laterally and vertically along the guide rail surface by means of gear engagement, pulling transmission and other modes, and the linkage of the lateral sway calibration module 14 and the vertical sway calibration module 13 is used to realize the simulation of ship sway motion.

2) Acquiring Wind Direction and Speed Data

The wind tunnel is set to have a 7-level wind speed range, and the wind direction and speed of the ship sway simulation platform at an inclination angle of 0° are measured as the reference values for real wind calibration; the sway control module 15 changes the rotation distance and speed parameters of the ship sway simulation platform through the host computer 16 to control the motion of the ship sway simulation platform first, 5° is input as the roll rotation distance, the data of wind direction and speed and the attitude is measured when the roll speed is respectively 2°/s, 5°/s, 10°/s and 15°/s, then the roll rotation distance is changed to 10° and 15° in sequence, and the above process is repeated. Due to the relatively small pitch amplitude of the actual ship during navigation, the ship sway simulation platform only moves at a pitch speed of 1°/s, 3°/s, 5°/s and 7°/s, the data of wind direction and speed and the attitude is measured when the pitch angle is respectively 2°, 4° and 8°, and the rotation distance and speed parameters of the calibration method can be modified according to the actual ship simulation situation. The ship real wind measuring device transmits the collected wind direction and speed data and the attitude data to the host computer 16, which are finally stored and sorted out to form a plurality of wind direction and speed and attitude measurement databases with the sway angle and speed as variables.

3) Calibrating Real Wind

The collected data is normalized before analysis of the wind direction and speed and attitude measurement databases; then, a BP neural network calibration model with the topological structure of 6×10×10×2 is initially constructed, wherein the input parameters include: roll angle, roll angular velocity, pitch angle, pitch angular velocity, measured wind direction and measured wind speed, and the output parameters include reference real wind direction and speed; and a Matlab program is prepared, the genetic algorithm is adopted to obtain optimal individuals to assign initial weight values and thresholds to the neural network, and the BP neural network calibration model that best maps the relationship between the ship spatial motion and the real wind measurement is obtained by training to form a ship real wind direction and speed calibration algorithm so as to obtain real wind direction and speed to calibrate the ship real wind measuring device and make a real-time correction to the wind direction and speed data measured in the actual ship.

1. A ship real wind measuring device calibration method, wherein the specific steps are as follows:
1) Establishing a Ship Sway Simulator
the ship sway simulator comprises a lateral sway calibration module (14), a vertical sway calibration module (13), a sway control module (15), a real wind measuring device fixed module (12) and a host computer (16);
the lateral sway calibration module (14) and the vertical sway calibration module (13) have the same structure, and both comprise a sway calibration floor guideway (3), a sway calibration platform guideway (5), a sway calibration slipway (8), a sway fixed base (4), a driving motor (7), a rack (9) and a screw (6); the upper surface of the sway fixed base (4) is a concave arc surface, two sway calibration floor guideways (3) and two sway calibration platform guideways (5) are symmetrically fixed on the concave arc surfaces of the sway fixed bases (4), and the two sway calibration platform guideways (5) are respectively located on the outer sides of the two sway calibration floor guideways (3) to form arc guide rail components; the lower surface of the sway calibration slipway (8) is a convex arc surface, two arc grooves are formed symmetrically in both ends of the lower surface and matched with the arc guide rail component of the sway fixed base (4) so that the sway calibration slipway (8) sways on the sway fixed base (4); the rack (9) is arranged in the middle of the lower surface of the sway calibration slipway (8), and a plurality of mounting holes are formed in the upper surface of the sway calibration slipway (8);
the driving motor (7) is installed on the outer side of the sway fixed base (4); one end of the screw (6) is connected with the driving motor (7) through a coupling, and the other end is engaged with the rack (9); and the sway calibration slipway (8) is driven by the driving motor (7) to move along the arc guide rail component on the sway fixed base (4) to realize the simulation of the ship sway attitude;
the lateral sway calibration module (14) and the vertical sway calibration module (13) are arranged at an included angle of 90° from top to bottom, and fixedly connected through the lower surface of the sway fixed base (4) located above and the upper surface of the sway calibration slipway (8) located below;
the real wind measuring device fixed module (12) comprises a supporting platform (1) and studs (2); a plurality of studs (2) are provided, the top ends thereof are symmetrically installed on the bottom of the supporting platform (1), and the bottom ends thereof are installed in the mounting holes in the upper surface of the sway calibration slipway (8) located above; a plurality of mounting holes are processed in the upper surface of the supporting platform (1) for installation of the real wind measuring device and adjustment of the installation direction according to experimental requirements;
the sway control module (15) is connected with the two driving motors (7) and the host computer (16); and the real wind measuring device is fixed on the supporting platform (1) through the mounting holes in the supporting platform (1) and connected with the host computer (16);
2) acquiring wind direction and speed data
first, placing the ship sway simulation platform vertically and statically, adopting the wind tunnel to simulate natural wind, installing the real wind measuring device on the ship sway simulation platform to measure the wind direction and speed, and transmitting the collected data to the host computer (16) as the real wind calibration reference values; then, sending instructions through the host computer (16) to the sway control module (15) which controls the swag angles and speeds of the lateral sway calibration module (14) and the vertical sway calibration module (13) to respectively simulate the roll and pitch motion of the ship at different sway speeds and angles; and finally, sorting out the data of the wind direction and speed collected by the real wind measuring device and the attitude of the ship sway simulation platform by the host computer (16) to form a wind direction and speed database with the sway angle and speed as variables.
3) Calibrating Real Wind
first, normalizing the data of wind direction and speed and ship attitude collected by the host computer (16) in step 2); then, constructing a BP neural network calibration model through the normalized data as follows: using the data of attitude and wind direction and speed as input parameters of the model, using the real wind calibration reference values as output parameters of the model, and adopting the genetic algorithm to obtain optimal individuals to assign initial weight values and thresholds to the neural network, wherein the input parameters include roll angle, roll angular velocity, pitch angle, pitch angular velocity, measured wind direction and measured wind speed, and the output parameters include real wind direction and speed of the wind tunnel measured by the ship real wind measuring device when the ship sway simulation platform is placed vertically and statically; obtaining the BP neural network calibration model that best maps the relationship between the ship spatial motion and the real wind measurement by training to form a ship real wind direction and speed calibration algorithm so as to realize the calibration of the ship real wind measuring device; and finally, inputting the data of wind direction and speed and ship attitude measured in the actual ship environment into the BP neural network calibration model to calculate the real-time real wind direction and wind speed so as to make a real-time correction to the data of wind direction and speed measured in the actual ship.
